(19) United States
(12) Patent Application Publication
(10) Pub. No.: US 2010/0237631 A1
(43) Pub. Date: Sep. 23, 2010

(54) Oscillating Power Generator

(76) Inventor: Howard Yu, Sunrise, FL (US)

Correspondence Address: GOLD & RIZVI, P.A., 11575 Heron Bay Blvd., SUITE 309, Coral Springs, FL, 33076, US

(21) Appl. No.: 12/407,954

(22) Filed: Mar. 20, 2009

(51) Int. Cl. F03G 7/08; F03G 7/10

(52) U.S. Cl. 290/1 R; 74/DIG. 9

(57) ABSTRACT

An electrical power generating apparatus utilizes an oscillating assembly to power at least one generator. The oscillating assembly comprises an off-balanced wheel assembly having either a partially circumferential wheel ring or a circular wheel ring with an off-balanced weight distribution, assembled to a centrally located wheel hub. The pendulum assembly is pivotally assembled to a frame via the wheel hub. A counterbalancing beam extends upwardly from the wheel hub, bisecting the wheel, placing equal mass to each side, such that the pendulum assembly is symmetric. Weights can be disposed upon each of the counterbalancing beam and the wheel assembly to aid in optimizing the teetering operation of the oscillating assembly. As the oscillating assembly operates, the motion is transferred to the at least generator which creates an electrical power output. An actuator injects energy into the oscillating motion to overcome any losses due to friction, air resistance, and such.

### BACKGROUND OF THE INVENTION

1. Field of the Invention

The present invention relates generally to a power generation apparatus. More particularly, the present invention relates to an oscillating device having at least an off-balanced wheel, which generates power provided by an oscillating motion.

2. Description of the Prior Art

Oscillating devices, such as a pendulum are known in the prior art. A pendulum is a weight suspended from a pivot so it can swing freely.

When a pendulum is displaced from its resting equilibrium position, it is subject to a restoring force due to gravity that will accelerate it back toward the equilibrium position. When released, the restoring force will cause it to oscillate about the equilibrium position, swinging back and forth. The time for one complete cycle, a left swing and a right swing, is called the period. From its discovery around 1602 by Galileo Galilei the regular motion of pendulums was used for timekeeping, and was the world's most accurate timekeeping technology until the 1930s. Pendulums are used to regulate pendulum clocks, and are used in scientific instruments such as accelerometers and seismometers. Historically they were used as gravimeters to measure the acceleration of gravity in geophysical surveys, and even as a standard of length.

The simple gravity pendulum is an idealized mathematical model of a pendulum. This is a weight (or bob) on the end of a massless cord suspended from a pivot, without friction. When given an initial push, it will swing back and forth at constant amplitude. In reduction to practice, pendulums are subject to friction and air drag, so the amplitude of their swings declines over time.

The known pendulums are provided having the pivot point located proximate a top portion of the pendulum assembly.

Energy sources are a resource that needs to be considered and respected, as a majority of today's resources, such as oil, are limited.

Therefore, an electrical power generating apparatus utilizing gravity is desired.

### SUMMARY OF THE INVENTION

The invention is directed to an electrical power generating apparatus utilizing a balanced pendulum assembly in communication with at least one generator.

In one general aspect of the present invention, the electrical power generating apparatus may include:
a frame having a base and a pendulum fulcrum interface;
a pendulum assembly having an off-balanced wheel assembly and a counterbalancing beam extending from a central fulcrum region of said off-balanced wheel assembly;
said off-balanced wheel assembly having a wheel ring disposed at a radius from a central hub located at said central fulcrum region, wherein the wheel only forms a partial circumference;
wherein said off-balanced wheel assembly is symmetric about said counterbalancing beam;
said central hub is assembled in a rotational engagement with said pendulum fulcrum interface;
at least one electrical generator engaging with an outer edge of said wheel ring; and
a power transfer member for obtaining electrical power from said at least one electrical generator.

Another aspect of the present invention incorporates a counterbalance weight at a distal end of the counterbalancing beam.

Yet another aspect incorporates a counterbalance weight at a distal end of the counterbalancing beam.

While another aspect incorporates an actuator engaging with the distal end of the counterbalancing beam, whereby the actuator injects work or energy via applying a force to the pendulum to overcome losses from mechanical losses, air resistance, and the like.

In a further aspect of the present invention, the pendulum can be optimized via additional of at least one of a wheel weight and a counterbalance weight.

In still a further aspect of the present invention, the at least one wheel weight and counterbalance weight can be assembled to the respective member via a mount which location can be adjusted along a longitudinal axis of the respective member, thus allowing for tuning of the pendulum.

While another aspect provides a plurality of generators, each generator engaging with the wheel ring edge.

Regarding another aspect, the power generation can be provided via a contact-less power generating configuration such as passing a magnetic material across a coil.

These and other aspects, features, and advantages of the present invention will become more readily apparent from the attached drawings and the detailed description of the preferred embodiments, which follow.

### BRIEF DESCRIPTION OF THE DRAWINGS

The preferred embodiments of the invention will hereinafter be described in conjunction with the appended drawings provided to illustrate and not to limit the invention, where like designations denote like elements, and in which:

FIG. 1 is an elevation view of a pendulum driven electrical power generating apparatus shown in a stationary state;

FIG. 2 is an elevation view of the pendulum driven electrical power generating apparatus of FIG. 1, shown in an operational state;

FIG. 3 is an elevation view of the pendulum assembly of the pendulum driven electrical power generating apparatus of FIG. 1, presenting the operational theory; and

FIG. 4 is an elevation view of an alternate embodiment of an oscillating apparatus having an off-balanced wheel and a contact-less, power-generating configuration.

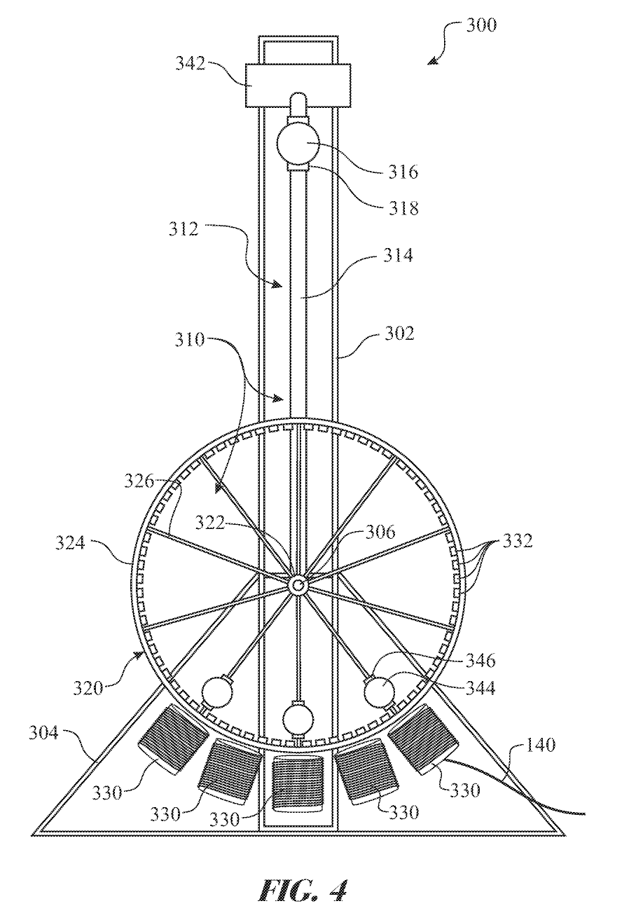

### DETAILED DESCRIPTION OF REPRESENTATIVE EMBODIMENTS

Shown throughout the Figures, the invention is directed to an oscillating electrical power generator.

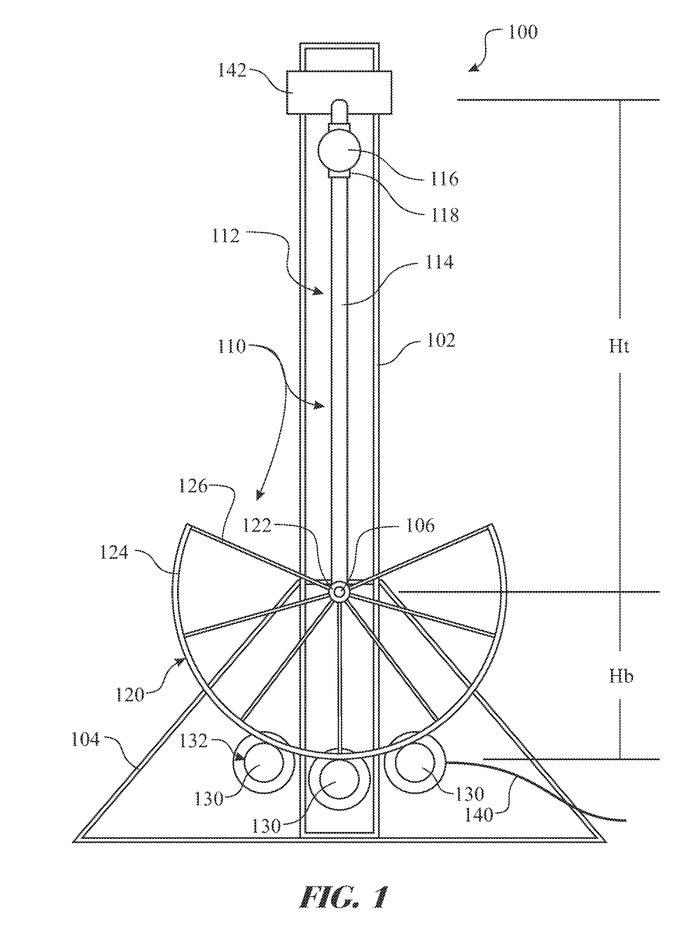

For purposes of description herein, the terms “upper”, “lower”, “left”, “rear”, “right”, “front”, “vertical”, “horizontal”, and derivatives thereof shall relate to the invention as oriented in FIG. 1. However, one will understand that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

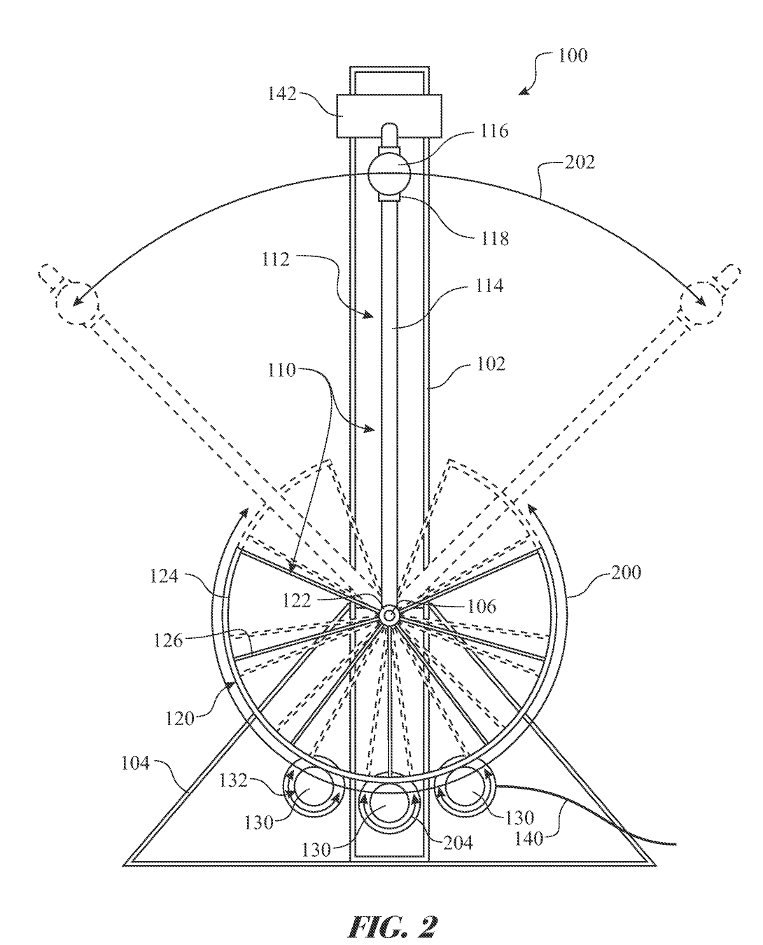

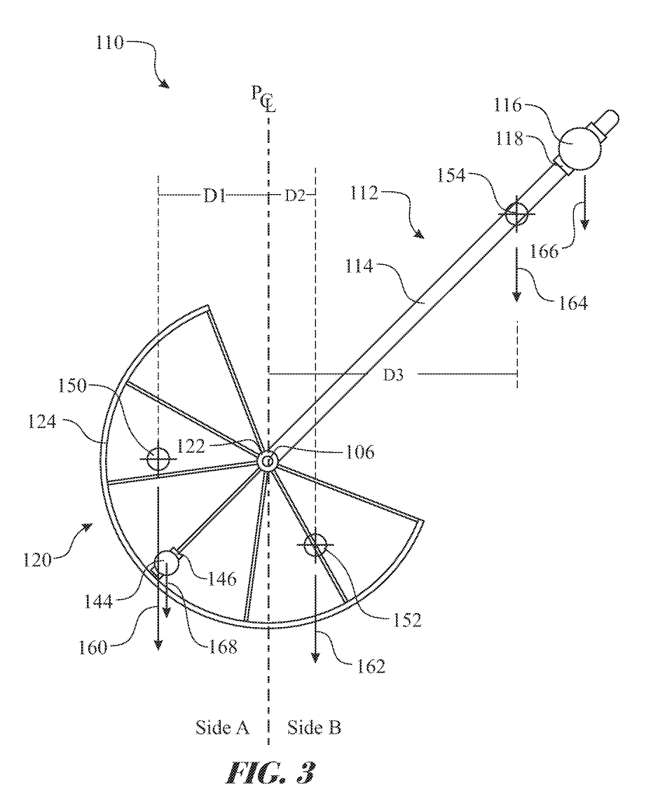

An oscillating power generation assembly 100 is initially represented in an elevation view illustrated in FIG. 1. The oscillating power generation assembly 100 shown in an operational state is presented in FIG. 2, with the physics behind the operation being detailed in FIG. 3.

The oscillating power generation assembly 100 is fabricated having a pendulum assembly 110 disposed within a frame assembly. The frame assembly comprises a frame 102 and a base 104. The base 104 provides physical support for the entire apparatus upon a floor. It is understood a wall mount can be utilized as an alternate mounting configuration for the apparatus. The frame 102 and base 104 can be fabricated of any reasonable material, including metal, wood, composite, any combination of materials, and the like. The frame assembly is designed to adequately support the pendulum assembly 110 within the frame assembly during operation.

The pendulum assembly 110 includes a counterbalancing beam 114 projecting upwards from an off-balanced wheel assembly 120. The first exemplary off-balanced wheel assembly 120 is fabricated having a wheel ring 124 that is formed in the shape of a non-circumferential circle having a radius from a wheel hub 122. The wheel ring 124 is preferred but not limited to having a circumference of between 180 degrees and 270 degrees. The non-circumferential circle shape creates an off-balanced condition, which causes the off-balanced wheel assembly 120 to oscillate. A series of radial members 126 can be disposed between the wheel hub 122 and the wheel ring 124. It is preferred that each radial member 126 includes features to minimize any resistance generated by air. It is understood that a solid member can be utilized replacing the series of radial members 126 as an alternate member for assembling the wheel ring 124 to the wheel hub 122. An optional counterbalance weight 116 can be affixed to the counterbalancing beam 114, providing a counterbalancing force into the operation of the oscillating power generation assembly 100. The counterbalance weight 116 can include a counterbalance weight mount 118 for adjustably assembling the counterbalance weight 116 to the counterbalancing beam 114. The counterbalance weight mount 118 allows the user to tune the overall operation of the pendulum assembly 110 by adjusting the position of the counterbalance weight 116 along a longitudinal axis of the counterbalancing beam 114. The pendulum assembly 110 is assembled to the frame assembly by inserting a pivot axle 106 through an aperture provided through the wheel hub 122.

The counterbalancing beam 114 extends from the wheel hub 122 along a distance/height Ht. The radius of the off-balanced wheel assembly 120 is represented as dimension Hb. It is preferred that Ht>Hb, more so, having a 3:1 ratio.

The pendulum assembly 110 pivots about the pivot axle 106. The motion of the off-balanced wheel assembly 120 is presented as a wheel ring rotation 200. The motion of the counter balance assembly 112 is presented as a counterbalancing beam rotation 202. The forces acting on the pendulum as a system can be divided into three contributors: a wheel side A centroid 150, a wheel side B centroid 152, and a counterbalance centroid 154. The wheel side A centroid 150 is the centroid location and effective weight of the portion of the off-balanced wheel assembly 120 that is located on side A of a centerline of the oscillating power generation assembly 100. The wheel side B centroid 152 is the centroid location and effective weight of the portion of the off-balanced wheel assembly 120 that is located on side B of a centerline of the oscillating power generation assembly 100. As the pendulum assembly 110 pivots, the total area or volume of each side A and B shifts and the location and effective forces of each of three primary contributors.

The operating forces of the pendulum assembly 110 are provided by a series of torques generated by a downward force multiplied by a distance between the centroid and the pivot point of the pivot axle 106 for each contributor. The weight and location of the counterbalance centroid 154 remains constant, while the distance from the centerline changes. Contrarily, the off-balanced wheel assembly 120 has a shift in both the effective weight and the location of the centroids 150, 152, as the effective mass is continuously shifting between each side of the centerline as the off-balanced wheel assembly 120 rotates. The three contributing torques are as follows:
a. D1*centroid A force 160
b. D2*centroid B force 162
c. D3*counterbalance centroid force 164

As the pendulum assembly 110 rotates clockwise, distance D3 increases, increasing torque component C (above). The rotation of the off-balanced wheel assembly 120 shifts the mass to the side with the direction of rotation. A clockwise rotation increases the mass on side A, while decreasing the mass on side B. Contrarily, a counterclockwise rotation decreases the mass on side A, while increasing the mass on side B. At some point in the rotation, the torque overcomes the inertial force cause the motion to slow, then stall and eventually reverse. The forces can also be considered in forms of transfer of energy between Kinetic and Potential energy. As the wheel assembly 120 rotates, the effective mass of the wheel assembly 120 shifts towards the side in the direction of rotation. The center of mass also increases in height (moving against a gravitational force); the Kinetic energy is reduced and converted to Potential energy. As the energy shifts from Kinetic energy to Potential energy, the oscillation slows. At one point in time, all of the energy is considered Potential energy and the oscillating motion stops. The potential energy is then converted into Kinetic energy, with the wheel assembly 120 accelerating in an opposite rotational direction.

An electrical circuit (not shown) would compensate for any impact resulting from the change in rotational direction of the generators 130. An actuator 142 is assembled to the frame assembly at a location to convey additional energy to the pendulum assembly 110. The actuator 142 can be of any known form factor using any reasonable energy source. One such example is a solar powered motor that engages with the counterbalancing beam 114 and increases the speed of rotation of the pendulum assembly 110. The actuator 142 can insert the force based upon a predetermined time span, a count of passes of the counterbalancing beam 114, a measurement of distance of travel of a feature of the pendulum assembly 110, a measurement of a peak angle of rotation of the pendulum assembly 110, and the like. Each of these can be accomplished via a sensor or series of sensors, a small computing device, and the like. Elements required to accomplish this are well known by those skilled in the art.

A wheel weight 144 can be assembled to the off-balanced wheel assembly 120 such as via a wheel weight mount 146 being affixed to one of the radial members 126. It is preferred that the wheel weight mount 146 is adjustably assembled to the radial member 126, allowing the adjustment along a longitudinal axis of the radial member 126. This adjustability can be utilized to optimize the oscillation of the pendulum assembly 110. The wheel weight 144 interjects a wheel weight force 168, adding an additional return torque into the equation. Comparably, the counterbalance weight 116 interjects a counterbalance weight force 166, adding an additional rotational torque into the equation. The location of the counterbalance weight 116 and the wheel weight 144 affect the distance from the centerline to each of the two forces 166, 168.

At least one generator 130 is providing in communication with the pendulum assembly 110, such to cause an armature (not shown but well understood) of the generator 130 being drive by the motion of the pendulum assembly 110. In the exemplary embodiment, a generator drive surface 132 of the generator 130 is in frictional communication with an outer surface of the wheel ring 124. The wheel ring rotation 200 of the wheel ring 124 drives the armatures of the generator 130 causing them to move in accordance with an armature rotation 204. It is understood the larger the radius Hb of the off-balanced wheel assembly 120, the longer the length of the wheel ring 124 surface, the faster the motion along the edge of the wheel ring 124, and the greater the time of rotation for each swing of the pendulum. Additionally, the smaller the diameter of the generator drive surface 132, the greater the resulting rotations of the armature. These factors impact the speed and time span in which the armatures of the generator 130 are being rotated. The generators 130 are fabricated with components to minimize friction and other losses commonly known with generators. The electrical output is conveyed via a power conductor 140.

The exemplary embodiment presented herein describes a contacting interface between an outer edge of the wheel ring 124 and the generator drive surface 132 of the generator 130. It is understood that alternate configurations can be utilized to convey the rotational energy of the pendulum assembly 110 to the generator 130. One such example would be a pulley system; another would be a series of gears, and the like.

A second exemplary embodiment is presented as an oscillating power generation assembly 300. The oscillating power generation assembly 300 is fabricated having a pendulum assembly 310 disposed within a frame assembly. The frame assembly comprises a frame 302 and a base 304, similar to the frame assembly previously described herein.

The pendulum assembly 310 can include an optional counterbalancing beam 314 projecting upwards from an off-balanced wheel assembly 320. The exemplary, off-balanced wheel assembly 320 is fabricated having a circular wheel ring 324 having a radius from a wheel hub 322. The off-balanced wheel assembly 320 would include an off-balanced weight such as at least wheel weight 344 causing the oscillating wheel assembly 320 to oscillate. The wheel weight 344 can be optionally, adjustably assembled to the radial members 326. A series of radial members 326 can be disposed between the wheel hub 322 and the wheel ring 324. It is preferred that each radial member 326 includes features to minimize any resistance generated by air. The radial members 326 would include the features previously herein. An optional counterbalance weight 316 can be affixed to the counterbalancing beam 314, providing a counterbalancing force into the operation of the oscillating power generation assembly 300. The counterbalance weight 316 can include a counterbalance weight mount 318 for adjustably assembling the counterbalance weight 316 to the counterbalancing beam 314, similar to that previously described. The counterbalance weight mount 318 allows the user to tune the overall operation of the pendulum assembly 310 by adjusting the position of the counterbalance weight 316 along a longitudinal axis of the counterbalancing beam 314. The pendulum assembly 310 is assembled to the frame assembly by inserting a pivot axle 306 through an aperture provided through the wheel hub 322. Although the exemplary embodiment in the illustrations presents a hub 322 is placed over an axle 306 it is understood that any fulcrum design can be utilized.

The oscillating power generation assembly 300 additionally presents a second embodiment for generating power. A series of magnets 332 are disposed about the perimeter of the wheel ring 324. It is preferred that they at least partially pass through providing magnetic exposure to the outer perimeter of the wheel ring 324. At least one coil 330 is located proximate a path formed by the passing of the magnets 332. As the magnets 332 pass through the magnetic flux of each coil 330, the change in flux density causes a current through each coil 330. This configuration minimizes any mechanical friction. An actuator 342 can be incorporated to re-introduce energy into the system to compensate for any losses due to resistance and friction.

Since any friction and resistance impacts the efficiency of the oscillating power generation assembly 100, it is suggested that the oscillating power generation assembly 100 be assembled within a vacuum or an environment having a reduced atmosphere to minimize resistance created by air.

It is recognized by the inventor that placement of the oscillating power generation assembly 100 onto another oscillating apparatus, such as a floating apparatus placed in a body of water, such as the ocean which has waves. The waves cause the floating apparatus to rock, thus transferring energy to the oscillating power generation assembly 100 to help overcome any losses due to friction or resistance.

While the preferred embodiments of the invention have been described above, it will be recognized and understood that various modifications can be made in the invention and the appended claims are intended to cover all such modifications which may fall within the spirit and scope of the invention.

I claim:

1. An electrical power generating apparatus comprising:
a frame having a base and a pendulum pivot interface;
a pendulum assembly having an off-balanced wheel assembly and a counterbalancing beam extending from a central pivot region of said off-balanced wheel assembly;
said off-balanced wheel assembly having a wheel ring disposed at a radius from a central hub located at said central pivot region, wherein the wheel only forms a partial circumference;
wherein said off-balanced wheel assembly is symmetric about said counterbalancing beam;
said central hub is assembled in a rotational engagement with said pendulum pivot interface;
at least one electrical generator engaging with an outer edge of said wheel ring; and
a power transfer member for obtaining electrical power from said at least one electrical generator.

2. An electrical power generating apparatus as recited in claim 1, the electrical power generating apparatus further comprising a plurality of generators engaging with an outer edge of said wheel ring.

3. An electrical power generating apparatus as recited in claim 1, the electrical power generating apparatus further comprising an actuator engaging with a distal end of the counterbalancing beam, applying additional energy to a rotation of the pendulum assembly.

4. An electrical power generating apparatus as recited in claim 3, the actuator incorporating a means to insert the force based upon at least one of:
a. a predetermined time span,
b. a count of passes of the counterbalancing beam,
c. a measurement of distance of travel of a feature of the pendulum assembly, and
d. a measurement of a peak angle of rotation of the pendulum assembly.

5. An electrical power generating apparatus as recited in claim 1, the electrical power generating apparatus further comprising a counterbalancing weight being assembled to the counterbalancing beam.

6. An electrical power generating apparatus as recited in claim 4, wherein said counterbalancing weight is adjustably assembled to the counterbalancing beam, allowing said counterbalancing weight to be adjusted to a position along a longitudinal axis of said counterbalancing beam.

7. An electrical power generating apparatus as recited in claim 1, the electrical power generating apparatus further comprising a wheel weight being assembled to a portion of said wheel assembly.

8. An electrical power generating apparatus as recited in claim 7, said wheel assembly further comprising a radial member disposed between said wheel ring and said central hub, wherein said wheel weight is adjustably assembled to said radial member of said wheel assembly, allowing said wheel weight to be adjusted to a position along a radial axis of said counterbalancing beam.

9. An electrical power generating apparatus comprising:
a frame having a base and a pendulum pivot interface;
a pendulum assembly having an off-balanced wheel assembly and a counterbalancing beam extending from a central pivot region of said off-balanced wheel assembly;
said off-balanced wheel assembly having a wheel ring disposed at a radius from a central hub located at said central pivot region, wherein the wheel only forms a partial circumference;
wherein said off-balanced wheel assembly is symmetric about said counterbalancing beam;
said central hub is assembled in a rotational engagement with said pendulum pivot interface;
at least one electrical generator engaging with said wheel assembly, transferring a rotational movement of said pendulum assembly to an armature of said electrical generator; and
a power transfer member for obtaining electrical power from said at least one electrical generator.

10. An electrical power generating apparatus as recited in claim 9, the electrical power generating apparatus further comprising a plurality of generators engaging with an outer edge of said wheel ring.

11. An electrical power generating apparatus as recited in claim 9, the electrical power generating apparatus further comprising an actuator engaging with a distal end of the counterbalancing beam, applying additional energy to a rotation of the pendulum assembly.

12. An electrical power generating apparatus as recited in claim 9, the electrical power generating apparatus further comprising a counterbalancing weight being assembled to the counterbalancing beam.

13. An electrical power generating apparatus as recited in claim 12, wherein said counterbalancing weight is adjustably assembled to the counterbalancing beam, allowing said counterbalancing weight to be adjusted to a position along a longitudinal axis of said counterbalancing beam.

14. An electrical power generating apparatus as recited in claim 9, the electrical power generating apparatus further comprising a wheel weight being assembled to a portion of said wheel assembly.

15. An electrical power generating apparatus comprising:
a frame having a base and a pendulum pivot interface;
a pendulum assembly having an off-balanced wheel assembly and a counterbalancing beam extending from a central pivot region of said off-balanced wheel assembly;
said off-balanced wheel assembly having a wheel ring disposed at a radius from a central hub located at said central pivot region, wherein the wheel only forms a partial circumference;
wherein said off-balanced wheel assembly is symmetric about said counterbalancing beam;
said central hub is assembled in a rotational engagement with said pendulum pivot interface;
an actuator engaging with a distal end of the counterbalancing beam, applying additional energy to a rotation of the pendulum assembly;
at least one electrical generator engaging with said wheel assembly, transferring a rotational movement of said pendulum assembly to an armature of said electrical generator; and
a power transfer member for obtaining electrical power from said at least one electrical generator.

16. An electrical power generating apparatus as recited in claim 15, the actuator incorporating a means to insert the force based upon at least one of:
a. a predetermined time span,
b. a count of passes of the counterbalancing beam,
c. a measurement of distance of travel of a feature of the pendulum assembly, and
d. a measurement of a peak angle of rotation of the pendulum assembly.

17. An electrical power generating apparatus as recited in claim 15, the electrical power generating apparatus further comprising a plurality of generators engaging with an outer edge of said wheel ring.

18. An electrical power generating apparatus as recited in claim 15, the electrical power generating apparatus further comprising a counterbalancing weight being assembled to the counterbalancing beam.

19. An electrical power generating apparatus as recited in claim 18, wherein said counterbalancing weight is adjustably assembled to the counterbalancing beam, allowing said counterbalancing weight to be adjusted to a position along a longitudinal axis of said counterbalancing beam.

20. An electrical power generating apparatus as recited in claim 15, the electrical power generating apparatus further comprising a wheel weight being assembled to a portion of said wheel assembly.
